(19) United States
(12) Patent Application Publication
(10) Pub. No.: US 2026/0012058 A1
(43) Pub. Date: Jan. 8, 2026

(54) ENCLOSED ROTATING ELECTRIC MACHINE

(71) Applicant: KABUSHIKI KAISHA TOYOTA JIDOSHOKKI, Aichi (JP)

(72) Inventor: Takafumi NAKAMURA, Aichi (JP)

(73) Assignee: KABUSHIKI KAISHA TOYOTA JIDOSHOKKI, Aichi (JP)

(21) Appl. No.: 19/249,000

(22) Filed: Jun. 25, 2025

(30) Foreign Application Priority Data
Jul. 4, 2024 (JP) 2024-108171

(51) Int. Cl. H02K 5/22; H02K 1/16; H02K 5/10

(52) U.S. Cl. CPC H02K 5/225; H02K 1/16; H02K 5/10; H02K 2203/06

(57) ABSTRACT

An enclosed rotating electric machine includes a stator, and coil ends; a lead drawn out from one of the coil ends; a connection terminal; a pair of end brackets; a lead insertion portion having a through hole; a terminal block to which the connection terminal is fastened, and that is disposed at a position to which the through hole is opened so that the terminal block is aligned with the through hole in the axial direction of the stator; a protective member that is inserted through the through hole and into which the lead is inserted, protects a portion of the lead, and seals a gap between the through hole and the lead. The protective member is accommodated in the lead insertion portion so that the protective member extends from the through hole toward an inner portion of the lead insertion space.

### CROSS-REFERENCE TO RELATED APPLICATION

This application claims priority to Japanese Patent Application No. 2024-108171 filed on Jul. 4, 2024, the entire disclosure of which is incorporated herein by reference.

The present disclosure relates to an enclosed rotating electric machine.

### BACKGROUND ART

An enclosed rotating electric machine includes an end bracket that covers a coil end of a stator. In addition, the enclosed rotating electric machine has a through hole through which a lead drawn from the coil end extends in the end bracket, and a gap between the through hole and the lead is sealed. For example, as disclosed in Japanese Patent Application Publication No. 2001-251089, a bus bar serving as a lead extends through a mounting hole provided in a case and a through portion provided in a shielding case, and is drawn out to an outside of the case. A rubber plug attached to the mounting hole is fitted into the through portion, and the bus bar is inserted into the rubber plug. Additionally, the bus bar drawn out from the case has a connection portion at an end thereof that is placed on a terminal block disposed outside the case. The connection portion placed on the terminal block and a terminal fitting of a motor cable placed over the connection portion are fastened to connect the bus bar and the motor cable.

When the connection portion of the bus bar drawn out through the through portion is being connected to the terminal block, as in the above-mentioned Publication, the rubber plug may interfere with the connection process.

### SUMMARY

In accordance with an aspect of the present disclosure, there is provided an enclosed rotating electric machine including: a stator including a stator core around which a coil is wound, and coil ends protruding from opposite end surfaces of the stator core in an axial direction of the stator core; a lead drawn out from one of the coil ends; a connection terminal connected to a tip end of the lead; a pair of end brackets covering stator end surfaces on opposite end of the stator in an axial direction of the stator, and defining accommodation spaces accommodating the coil ends; a lead insertion portion provided in one of the end brackets covering one of the coil ends from which the lead is drawn out, the lead insertion portion protruding from a peripheral surface of the end bracket in a radial direction of the stator, defining a lead insertion space in communication with one of the accommodation spaces, and having a through hole from which the lead inserted through the lead insertion space is drawn out from the lead insertion portion; a terminal block to which the connection terminal is fastened, the terminal block being disposed outward in the radial direction of the stator, and disposed at a position to which the through hole is opened so that the terminal block is aligned with the through hole in the axial direction of the stator; a protective member that is inserted through the through hole and into which the lead is inserted, the protective member protecting a portion of the lead, the protective member sealing a gap between the through hole and the lead, wherein the protective member is accommodated in the lead insertion portion so that the protective member extends from the through hole toward an inner portion of the lead insertion space.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view illustrating an enclosed rotating electric machine according to an embodiment;

FIG. 2 is a perspective view illustrating the enclosed rotating electric machine according to the embodiment;

FIG. 3 is a perspective view illustrating a lead insertion portion, a lead, a protective member, a mounting member, and a terminal block;

FIG. 4 is a perspective view illustrating the protective member;

FIG. 5 is a perspective view illustrating the lead insertion portion;

FIG. 6 is an enlarged cross-sectional view illustrating the protective member in a lead insertion space; and

FIG. 7 is an enlarged cross-sectional view of a protective member according to another example.

### DETAILED DESCRIPTION OF THE EMBODIMENTS

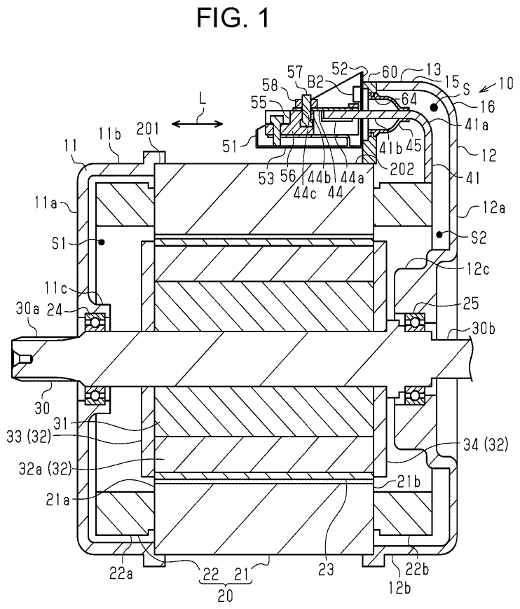

The following will describe an embodiment of an enclosed rotating electrical machine with reference to FIGS. 1 to 6.

The enclosed rotating electric machine is used as a travel motor and a cargo handling motor in an industrial vehicle. The enclosed rotating electric machine is a three-phase induction motor.

### Overall Enclosed Rotating Electric Machine

As illustrated in FIGS. 1, 2, and 3, an enclosed rotating electric machine 10 includes a first end bracket 11, a second end bracket 12, a stator 20, a rotor 23, three leads 41, a terminal block housing 51, a terminal block 55, and a terminal block cover 70. The enclosed rotating electric machine 10 also include protective members 45 into which the leads 41 drawn out from the second end bracket 12 are inserted, and a mounting member 60 to which the protective members 45 are mounted.

### Stator

As illustrated in FIG. 1, the stator 20 includes a stator core 21 and a coil 22. In the following description, since an axial direction L of the stator 20 coincides with an axial direction of the stator core 21, the axial direction of the stator core 21 is also referred to as the “axial direction L.” The stator core 21 is formed with electromagnetic steel sheets stacked in the axial direction L. The coil 22 is wound around the stator core 21. The stator core 21 has a first stator end surface 21a corresponding to one end surface of the stator core 21 in the axial direction L, and a second stator end surface 21b corresponding to the other end surface of the stator core 21 in the axial direction L. Thus, a first end surface of the stator 20 in the axial direction L corresponds to the first stator end surface 21a, and a second end surface of the stator 20 in the axial direction L corresponds to the second stator end surface 21b. A first coil end 22a protrudes from the first stator end surface 21a, and a second coil end 22b protrudes from the second stator end surface 21b of the stator core 21. Thus, the stator 20 has the coil 22 wound around the stator core 21 and the first coil end 22a and the second coil end 22b protruding from the opposite end surfaces of the stator core 21 in the axial direction L.

### Lead

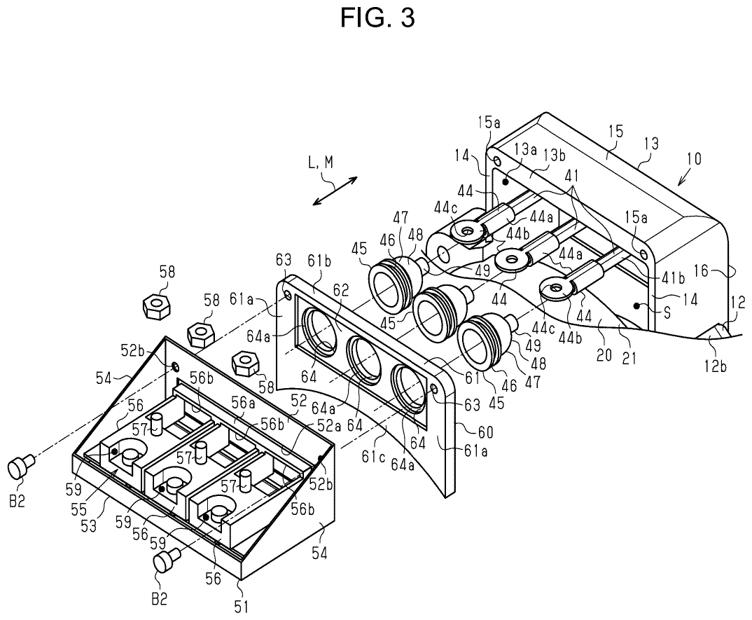

As illustrated in FIGS. 1 and 3, the three leads 41 are drawn out from the second coil end 22b of the stator 20. The three leads 41 electrically connect the stator 20 to an inverter (not illustrated). The three leads 41 are for the U-phase, V-phase, and W-phase of the enclosed rotating electric machine 10. The leads 41 each have a circular cross section at a base end on the second coil end 22b side, but a flattened circular cross section at a tip end due to the connection terminals 44 being crimped to the leads 41. As described above, the connection terminals 44 are connected to the tip ends of the leads 41. The connection terminals 44 have crimped portions 44a crimped to the leads 41, and the terminal portions 44b extending from the crimped portions 44a, respectively. The terminal portions 44b each have a disk shape and has an insertion hole 44c at a center thereof.

### Rotor

A rotor 23 is disposed inside the stator 20 in a radial direction thereof. The rotor 23 includes a shaft 30, a rotor core 31, and a secondary conductor 32. The shaft 30 is disposed at the center of the rotor core 31. The rotor core 31 is fixed to the shaft 30 on an inner side in the radial direction of the stator 20. The rotor core 31 is formed with electromagnetic steel sheets stacked. The secondary conductor 32 has a rotor bar 32a, a first end plate 33 and a second end plate 34. The rotor bar 32a is embedded in the rotor core 31. The first end plate 33 is disposed on one end surface of the rotor core 31 in an axial direction thereof, and the second end plate 34 is disposed on the other end surface of the rotor core 31 in the axial direction thereof.

### First End Bracket and Second End Bracket

The first end bracket 11 is attached to a first end 201 of the stator 20 in the axial direction L thereof. The second end bracket 12 is attached to a second end 202 of the stator 20 in the axial direction L.

The first end bracket 11 has a first plate portion 11a facing the first stator end surface 21a and the first end plate 33, and a first peripheral wall portion 11b extending in a cylindrical shape from an edge portion of the first plate portion 11a toward the stator 20. A first accommodation space S1 is defined inside the first end bracket 11. The first accommodation space S1 is defined by an inner surface of the first plate portion 11a and an inner surface of the first peripheral wall portion 11b. The first end bracket 11 has a first bearing holding portion 11c that protrudes from a central portion of the first plate portion 11a toward the first accommodation space S1. A first bearing 24 is held in the first bearing holding portion 11c. Additionally, the first coil end 22a and the first end plate 33 are accommodated in the first accommodation space S1.

The second end bracket 12 has a second plate portion 12a facing the second stator end surface 21b and the second end plate 34, a second peripheral wall portion 12b extending in a cylindrical shape from an edge portion of the second plate portion 12a toward the stator 20, and a lead insertion portion 13 protruding in a radial direction of the second peripheral wall portion 12b from a peripheral surface of the second peripheral wall portion 12b. The lead insertion portion 13 will be described in detail later.

A second accommodation space S2 is defined inside the second end bracket 12. The second accommodation space S2 is defined by an inner surface of the second plate portion 12a and an inner surface of the second peripheral wall portion 12b. The second end bracket 12 has a second bearing holding portion 12c that protrudes from a central portion of the second plate portion 12a toward the second accommodation space S2. A second bearing 25 is held in the second bearing holding portion 12c. Additionally, the second accommodation space S2 accommodates the second coil end 22b and the second end plate 34, and also accommodates portions of the three leads 41.

As described above, the enclosed rotating electric machine 10 includes the first end bracket 11 and the second end bracket 12 as a pair of end brackets. The first end bracket 11 covers the first stator end surface 21a in the axial direction L of the stator 20, and defines the first accommodation space S1 accommodating the first coil end 22a. In addition, the second end bracket 12 covers the second stator end surface 21b in the axial direction L of the stator 20, and defines the second accommodation space S2 accommodating the second coil end 22b. Therefore, the enclosed rotating electric machine 10 includes the first end bracket 11 and the second end bracket 12 that cover both of the stator end surfaces 21a, 21b of the stator 20.

Further, a first end portion 30a of the shaft 30 is rotatably supported by the first end bracket 11 via the first bearing 24. A second end portion 30b of the shaft 30 is rotatably supported by the second end bracket 12 via the second bearing 25

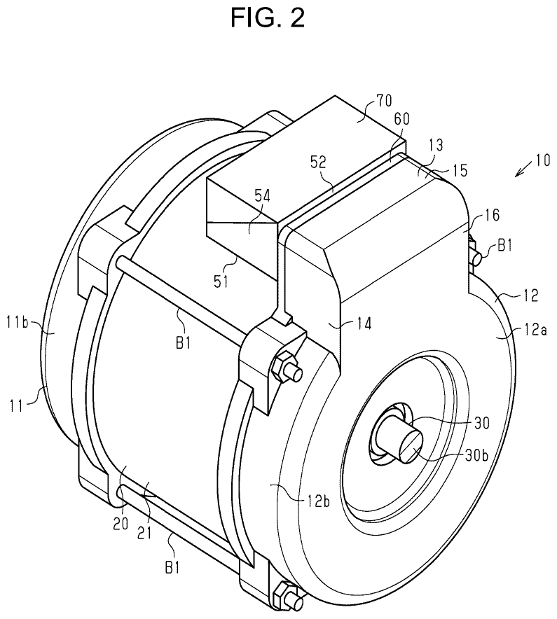

As illustrated in FIGS. 1 and 2, the first end bracket 11 and the second end bracket 12 are connected using a plurality of connecting bolts B1 with the stator 20 positioned between the first plate portion 11a and the second plate portion 12a. The first end portion 30a of the shaft 30 protrudes from the first plate portion 11a of the first end bracket 11, and the second end portion 30b of the shaft 30 protrudes from the second plate portion 12a of the second end bracket 12.

### Lead Insertion Portion

As illustrated in FIGS. 1 and 3, the lead insertion portion 13 is provided in the second end bracket 12 which covers the second coil end 22b from which the leads 41 are drawn out. The lead insertion portion 13 protrudes in the radial direction of the stator 20 from the peripheral surface of the second peripheral wall portion 12b. The lead insertion portion 13 has a pair of side plates 14 extending from the peripheral surface of the second peripheral wall portion 12b, a top plate 15 mounted over the pair of side plates 14, and a back plate 16 extending from the second plate portion 12a and connected to the side plates 14 and the top plate 15.

A lead insertion space S is defined inside the lead insertion portion 13. The lead insertion space S is defined by the pair of side plates 14, the top plate 15, and the back plate 16. Further, the lead insertion portion 13 defines an opening 13a through which the lead insertion space S is opened to an outside of the lead insertion portion 13. The opening 13a is defined by the pair of side plates 14 and the top plate 15. The opening 13a allows the lead insertion space S to be opened to a side opposite from the second plate portion 12a in the axial direction L of the stator 20. The lead insertion portion 13 has an insertion portion end surface 13b surrounding the opening 13a. The insertion portion end surface 13b is formed of end surfaces of the pair of side plates 14 and the top plate 15, which extend along the opening 13a. In the insertion portion end surface 13b, two screw holes 15a are formed in a portion formed by the top plate 15. The screw holes 15a are opened to the same direction as the lead insertion space S.

The lead insertion space S is in communication with the second accommodation space S2, and extends in the radial direction of the stator 20 from the second accommodation space S2. The three leads 41 drawn out from the second coil end 22b extend in the radial direction of the stator 20 from the second coil end 22b toward the lead insertion space S in the second accommodation space S2. The three leads 41 are bent in the lead insertion space S toward the opening 13a, and extend in the axial direction L of the stator 20 toward the opening 13a. The three leads 41 are drawn out to the outside of the second end bracket 12 via through holes 64 provided in the opening 13a of the lead insertion portion 13.

Therefore, the three leads 41 have, respectively, bent portions 41a bent toward the opening 13a, and straight portions 41b extending straight from the bent portions 41a toward the opening 13a. The straight portions 41b extend straight in the axial direction L of the stator 20 inside the lead insertion portion 13.

### Mounting Member

The mounting member 60 is a member for mounting the protective members 45 into which the leads 41 are inserted. The mounting member 60 is attached to the insertion portion end surface 13b of the lead insertion portion 13. The mounting member 60 is formed of a metal plate. The mounting member 60 has a frame portion 61 having a substantially rectangular frame shape, and a support portion 62 extending from an inside of the frame portion 61. The frame portion 61 has a pair of first wall portions 61a extending along the side plates 14, a second wall portion 61b extending along the top plate 15, and a third wall portion 61c extending along an outer peripheral surface of the stator core 21. Holes 63 are formed at intersections of the first wall portions 61a and the second wall portion 61b. The holes 63 extend through the frame portion 61 in a thickness direction thereof.

The support portion 62 extends from the pair of first wall portions 61a, the second wall portion 61b, and the third wall portion 61c to an inner side of the frame portion 61. The support portion 62 has three through holes 64. The through holes 64 each are a circular hole. The support portion 62 has engaging edge portions 64a extending toward the through holes 64.

The mounting member 60 is mounted to the insertion portion end surface 13b of the lead insertion portion 13. Thus, the through holes 64 are defined in the lead insertion portion 13.

### Protective Member

The protective members 45 are mounted to the mounting member 60 in a state where the protective members 45 are inserted through the through holes 64. That is, the protective members 45 are attached to the mounting member 60 that defines the through holes 64. The protective members 45 protect portions of the leads 41 inserted into the protective members 45. The protective members 45 each are what is called a grommet. The protective members 45 are made of a flame-retardant material, and elastically deformable. The protective members 45 are made of silicone rubber. The material of the protective members 45 may be ethylene propylene rubber (EPDM) or chloroprene rubber (CP).

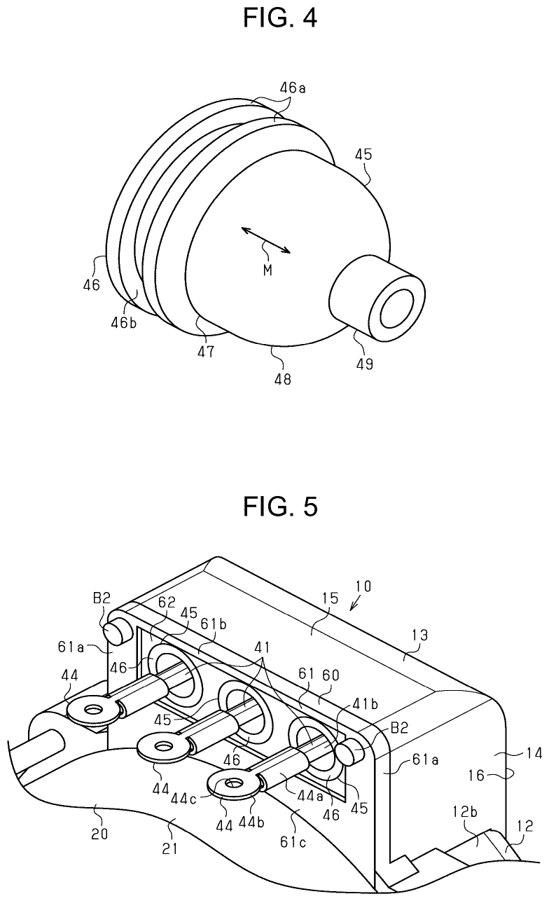

As illustrated in FIG. 4, the protective members 45 each have a thin cylindrical shape. The protective members 45 each have a mounting tubular portion 46, a cylindrical portion 47 extending in a cylindrical shape from the mounting tubular portion 46, a reduced diameter portion 48 extending in a conical cylindrical shape from the cylindrical portion 47, and a contact portion 49 extending in a cylindrical shape from the reduced diameter portion 48.

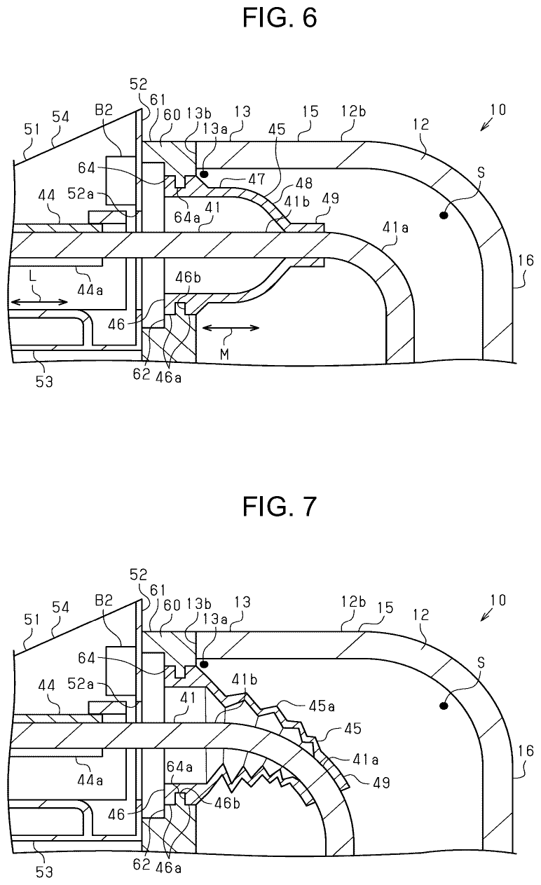

As illustrated in FIG. 6, an outer diameter of the mounting tubular portion 46 is slightly smaller than a diameter of each of the through holes 64 of the mounting member 60. The mounting tubular portion 46 has a pair of groove forming portions 46a protruding from an outer peripheral surface of the mounting tubular portion 46. The groove forming portions 46a are spaced from each other in an axial direction M of the protective members 45, and extend in a circumferential direction of the mounting tubular portion 46. A groove 46b is formed between the groove forming portions 46a. An outer diameter of the mounting tubular portion 46 at each of the groove forming portions 46a is slightly smaller than the diameter of each of the through holes 64, and the outer diameter of the mounting tubular portion 46 at the groove 46b is slightly smaller than the diameter of each of the through holes 64. The engaging edge portions 64a, which correspond to edges of the support portion 62 that defines the through holes 64, fit into the groove 46b. As a result, the mounting tubular portion 46 is mounted to the edge of the mounting member 60 that defines the through holes 64. Accordingly, the protective members 45 are mounted to the mounting member 60.

An inner diameter of each of the mounting tubular portion 46 and the cylindrical portion 47 is greater than a long side dimension of a portion of each of the leads 41 having a flattened circular cross section. The inner diameter and the outer diameter of the reduced diameter portion 48 gradually decrease from the cylindrical portion 47 toward the contact portion 49. An inner diameter of the contact portion 49 is smaller than the long side dimension of a portion of each of the leads 41 having a flattened circular cross section. Further, the outer diameter of the contact portion 49 is smaller than that of the reduced diameter portion 48. The contact portion 49 is elastically deformed and in close contact with the outer surface of its associated one of the leads 41.

As described above, the protective members 45 have, respectively, the mounting tubular portions 46 to be attached to the engaging edge portions 64a of the mounting member 60, the contact portions 49 in close contact with their associated leads 41, and the cylindrical portions 47 and the reduced diameter portions 48 located between the mounting tubular portions 46 and the contact portions 49. The cylindrical portions 47 and the reduced diameter portions 48 each have a larger diameter than that of each of the contact portions 49.

A dimension of each of the protective members 45 in the axial direction M is slightly smaller than a length of each of the straight portions 41b of the leads 41. Therefore, the protective members 45 has a length that allows the straight portions 41b to pass through their associated mounting tubular portions 46, the cylindrical portions 47, the reduced diameter portions 48, and the contact portions 49, and allows the contact portions 49 to be in close contact with their associated straight portions 41b.

### Terminal Block Housing

As illustrated in FIG. 3, the terminal block housing 51 is attached to the lead insertion portion 13 together with the mounting member 60. The terminal block housing 51 has a connecting plate portion 52 that is fastened together with the mounting member 60 and the lead insertion portion 13, a support plate portion 53 that extends in a plate shape from the connecting plate portion 52, and side plate portions 54 connected to the connecting plate portion 52 and the support plate portion 53. The connecting plate portion 52 has a rectangular frame shape extending along an outer shape of the mounting member 60. The connecting plate portion 52 has one opening 52a through which the three leads 41 extend. The connecting plate portion 52 also has two mounting holes 52b. The two mounting holes 52b are disposed on opposite side of the opening 52a, in an end opposite from the support plate portion 53. Bolts B2 inserted through the mounting holes 52b are inserted through the holes 63 of the mounting member 60, and screwed into the screw holes 15a the lead insertion portion 13. As a result, the terminal block housing 51 is attached to the lead insertion portion 13 together with the mounting member 60.

### Terminal Block

The terminal block 55 is supported by the support plate portion 53 of the terminal block housing 51. The terminal block 55 has three terminal fastening portions 56 and a bridging piece 56a mounted over the three terminal fastening portions 56. The terminal fastening portions 56 have fastening bolts 57 protruding from the terminal fastening portions 56, respectively. The terminal fastening portions 56 include connection recesses 59, respectively, to which connection wires connected to an inverter (not illustrated) are connected. The bridging piece 56a is mounted over the three terminal fastening portions 56, and connects the three terminal fastening portions 56 together. Recesses 56b recessed in the axial direction L of the stator 20 are defined between the terminal fastening portions 56 and the bridging piece 56a.

The three terminal fastening portions 56 are provided at positions extended in the axial direction L of the stator 20 from the lead insertion portion 13. The terminal fastening portions 56 are disposed at positions to which the through holes 64 are opened and aligned with the through holes 64 in the axial direction L of the stator 20. Further, the fastening bolts 57 are disposed at positions adjacent to the through holes 64 in the axial direction L of the stator 20. Therefore, the terminal block 55 supported by the terminal block housing 51 is disposed outward in the radial direction of the stator 20, and is disposed at a position to which the through holes 64 are opened so that the terminal block 55 is aligned with the through holes 64 in the axial direction L of the stator 20.

As illustrated in FIG. 1, in the connection terminals 44 drawn out from the lead insertion portion 13, the fastening bolts 57 are inserted into the insertion holes 44c, and fastening nuts 58 are screwed onto the fastening bolts 57, thereby fastening the connection terminals 44 to the terminal block 55.

### Terminal Block Cover

As illustrated in FIG. 2, the terminal block cover 70 is attached to the terminal block housing 51. The terminal block cover 70 covers the terminal block 55 supported by the support plate portion 53, and also covers the three connection terminals 44 fastened to the terminal block 55 and portions of the leads 41.

### Lead and Protective Member

As illustrated in FIGS. 1 and 6, the terminal block 55 is disposed outward in the radial direction of the stator 20 and arranged in line with the through holes 64 in the axial direction L of the stator 20. The connection terminals 44 are aligned with the lead insertion portion 13 in the axial direction L of the stator 20, and are fastened to the fastening bolts 57 of the terminal block 55 outside the lead insertion portion 13.

On the other hand, the protective members 45 are accommodated inside the lead insertion portion 13 so as to extend from the through holes 64 toward an inner portion of the lead insertion space S. Moreover, the protective members 45 are aligned with the connection terminals 44 in the axial direction L of the stator 20. In other words, the protective members 45 extend in a direction opposite to a direction in which the connection terminals 44 extend from the through holes 64. The contact portions 49 of the protective members 45 are in close contact with portions of the leads 41 inside the lead insertion portion 13. As a result, the protective members 45 seal gaps between the through holes 64 and the leads 41.

The leads 41 have the straight portions 41b that extend straight in the axial direction L of the stator 20 inside the lead insertion portion 13. The straight portions 41b of the leads 41 are inserted into the protective members 45. The contact portions 49 of the protective members 45 are in close contact with the straight portions 41b of the leads 41. As a result, the protective members 45 prevent entrance of a foreign object into the through holes 64 and protect the leads 41.

### Method of Fastening Connection Terminal to Terminal Block

Before the first end bracket 11 and the second end bracket 12 are assembled to the stator 20, an assembler attaches the protective members 45 to the leads 41 to which the connection terminals 44 are attached. At this time, the connection terminals 44 are inserted into the protective members 45 from the contact portions 49 side of the protective members 45, of the opposite sides of the protective members 45, in the axial direction M. Elastic deformation of the contact portions 49 allows the terminal portions 44b to pass through the contact portions 49. After the terminal portions 44b and the crimped portions 44a pass through the contact portions 49, the protective members 45 are attached to the outside of the leads 41. At this time, the connection terminals 44 protrude outward beyond the mounting tubular portions 46 of the protective members 45.

Then, the assembler attaches the first end bracket 11 and the second end bracket 12 to the stator 20. At this time, the assembler draws the connection terminals 44 of the three leads 41 out from the opening 13a of the lead insertion portion 13 through the lead insertion space S. Then, the assembler connects the first end bracket 11 and the second end bracket 12 with the connecting bolts B1, and attaches the first end bracket 11 and the second end bracket 12 to the stator 20.

Next, the assembler inserts the protective members 45 into the through holes 64 of the mounting member 60 from the mounting tubular portion 46 side of the opposite sides of the protective members 45 in the axial direction M. Then, the protective members 45 are integrated with the mounting member 60 by engaging the engaging edge portions 64a of the support portion 62 with the groove 46b.

Next, the assembler causes the bolts B2 inserted into the mounting holes 52b of the terminal block housing 51 to pass through the holes 63 of the mounting member 60, and screws the bolts B2 into the screw holes 15a of the lead insertion portion 13. As a result, the terminal block housing 51 is mounted to the lead insertion portion 13 together with the mounting member 60. Then, the protective members 45 are accommodated in the lead insertion space S of the lead insertion portion 13.

When the terminal block housing 51 and the mounting member 60 are mounted to the lead insertion portion 13, the assembler causes the connection terminals 44 protruding from the mounting tubular portion 46 to pass through the opening 52a of the terminal block housing 51 and through the recesses 56b of the terminal block 55, and positions the connection terminals 44 above the terminal fastening portions 56.

Next, the assembler inserts the fastening bolts 57 protruding from the terminal block 55 into the insertion holes 44c of the connection terminals 44, and screws the fastening nuts 58 onto the fastening bolts 57. Thus, the connection terminals 44 are fastened to the terminal fastening portions 56, respectively.

### Operation of Embodiment

The protective members 45 are accommodated in the lead insertion portion 13 so as to extend from the through holes 64 toward the inner portion of the lead insertion space S. Therefore, the protective members 45 do not protrude from the lead insertion portion 13 in the axial direction L of the stator 20.

### Effects of Embodiment

The above-described embodiment offers the following advantageous effects.

(1) The protective members 45 do not project out from the lead insertion portion 13 in the axial direction L of the stator 20. Thus, the protective members 45 are disposed opposite from the terminal block 55 with respect to the through holes 64. As a result, the protective members 45 do not extend from the through holes 64 toward the terminal block 55, and are therefore not present in the vicinity of the terminal block 55. Therefore, when the connection terminals 44 are being fastened to the terminal fastening portions 56, the protective members 45 do not interfere with the fastening of the connection terminals 44.

(2) The protective members 45 are inserted through the through holes 64 through which the leads 41 extend, and seal gaps between the through holes 64 and the leads 41. The protective members 45 do not extend from the through holes 64 toward the connection terminals 44, but extend in a direction opposite from the connection terminal 44. Therefore, the contact portions 49 of the protective members 45 are in close contact with portions of the leads 41 without being in close contact with the connection terminals 44. With this configuration, the protective members 45 do not have to meet the material requirements in a case where the protective members 45 are to be placed in contact with the connection terminals 44, which broadens the range of material choices for the protective members 45.

(3) The mounting member 60 is attached to the insertion portion end surface 13b of the lead insertion portion 13. The mounting member 60 has the three through holes 64, and the protective members 45 are inserted through the through holes 64. For example, a configuration in which the mounting member 60 is made of an elastically deformable material, and the mounting member 60 is placed in close contact with the leads 41 inserted through the through holes 64 may be considered. In this case, however, the thickness of the mounting member 60 is increased. This may result in tear of the mounting member 60 when the terminal portions 44b are being inserted therethrough, which is not preferable.

In contrast, in the present embodiment, the protective members 45 are thin, which allows the terminal portions 44b to be easily inserted therethrough. Therefore, using the protective members 45 having a thin-walled cylindrical shape allows the protective members 45 to be in close contact with the leads 41 without causing damage to the protective members 45. In addition, the protective members 45 are accommodated in the lead insertion portion 13. As a result, even if the protective members 45 each having a cylindrical shape and having a length are used, it is possible to prevent the protective members 45 from being in contact with the connection terminals 44 or interfering due to the lengths of the protective members 45.

(4) The protective members 45 have the cylindrical portions 47 each having a larger diameter than that of each of the contact portions 49. Therefore, even if bending deformation occurs in the leads 41 on the through holes 64 side relative to portions of the leads 41 in close contact with the contact portions 49, such bending deformation occurs inside the cylindrical portions 47. This suppresses contact of the deformed leads 41 with the inner peripheral surfaces of the protective members 45, thereby preventing the protective members 45 from being pressed and coming out of the through holes 64 by a restoring force of the leads 41 to their original shape.

(5) The leads 41 have the straight portions 41b that extend straight in the axial direction L of the stator 20 inside the lead insertion portion 13. The protective members 45 each have a length that allows its associated one of the straight portions 41b to be inserted through and allows its associated one of the contact portions 49 to be in contact with the straight portion 41b. As a result, contact of the contact portions 49 with the deformed portions of the leads 41 may be prevented. This prevents the protective members 45 from being pressed and coming out of the through holes 64 by a restoring force of the leads 41 to their original shape.

### Modification

The present embodiment may be modified in various manners, as exemplified below. The above-described embodiment and the following modifications may be combined within the scope consistent with the present disclosure.

As illustrated in FIG. 7, the protective members 45 each may have a peripheral wall 45a formed in a bellows shape extending in the axial direction M of the protective members 45. In this case, the peripheral walls 45a of the protective members 45 are formed in portions where the cylindrical portions 47 and the reduced diameter portions 48 are formed in the above embodiment. That is, the peripheral walls 45a are interposed between the mounting tubular portions 46 and the contact portions 49. In this configuration, the peripheral walls 45a are likely to change their shape in accordance with the deformation of the leads 41. Therefore, even if the contact portions 49 are in close contact with the bending-deformed portions of the leads 41, the protective members 45 change their shape in accordance with the shapes of the leads 41 by deforming the peripheral walls 45a having a bellows shape. This prevents the protective members 45 from being pressed and coming out of the through holes 64 by a restoring force of the leads 41 to their original shape.

The connection terminals 44 each may be a terminal other than a crimped terminal.

The protective members 45 each do not have to include the cylindrical portion 47, and may have a conical cylindrical shape with the reduced diameter portion 48 interposed between the mounting tubular portion 46 and the contact portion 49.

The length of each of the protective members 45 in the axial direction M may be changed as appropriate.

The method of mounting the protective members 45 to the mounting member 60 does not have to be made by engaging the engaging edge portions 64a with the grooves 46b. For example, the mounting tubular portions 46 of the protective members 45 may be welded, glued, or screwed to the mounting member 60.

The terminal block 55 does not have to be supported by the terminal block housing 51. For example, the terminal block 55 may be directly attached to the mounting member 60.

The opening 13a of the lead insertion portion 13 may be eliminated, the mounting member 60 may be eliminated, and the through holes 64 may be formed in the lead insertion portion 13.

The protective members 45 may include holding pieces, respectively, extending from portions of the mounting tubular portion 46 to the connection terminals 44. The holding pieces are used when the protective members 45 are inserted into the through holes 64, and the like.

### Additional Notes

The following will describe a technical idea that can be grasped from the embodiment and its modifications.

The protective member is made of an elastically deformable and flame-retardant material.

What is claimed is:

1. An enclosed rotating electric machine comprising:
a stator including a stator core around which a coil is wound, and coil ends protruding from opposite end surfaces of the stator core in an axial direction of the stator core;
a lead drawn out from one of the coil ends;
a connection terminal connected to a tip end of the lead;
a pair of end brackets covering stator end surfaces on opposite end of the stator in an axial direction of the stator, and defining accommodation spaces accommodating the coil ends;
a lead insertion portion provided in one of the end brackets covering the one of the coil ends from which the lead is drawn out, and protruding from a peripheral surface of the one of the end brackets in a radial direction of the stator, the lead insertion portion defining a lead insertion space in communication with one of the accommodation spaces, and having a through hole through which the lead inserted through the lead insertion space is drawn out from the lead insertion portion;
a terminal block to which the connection terminal is fastened, the terminal block being disposed outward in the radial direction of the stator, and disposed at a position to which the through hole is opened so that the terminal block is aligned with the through hole in the axial direction of the stator; and
a protective member having a tubular shape that is inserted through the through hole and into which the lead is inserted, the protective member protecting a portion of the lead,
the protective member sealing a gap between the through hole and the lead, wherein
the protective member is accommodated in the lead insertion portion so that the protective member extends from the through hole toward an inner portion of the lead insertion space.

2. The enclosed rotating electric machine according to claim 1, wherein
a mounting member that defines the through hole is attached to the lead insertion portion,
the protective member has a cylindrical shape, and
the protective member includes:
a mounting tubular portion mounted to an edge of the mounting member that defines the through hole;
a contact portion in close contact with the lead; and
a cylindrical portion located between the mounting tubular portion and the contact portion, and having a larger diameter than a diameter of the contact portion.

3. The enclosed rotating electric machine according to claim 2, wherein
the lead has a straight portion that extends straight in the axial direction of the stator inside the lead insertion portion, and
the protective member has a length that allows the straight portion to extend through the mounting tubular portion, the cylindrical portion, and the contact portion, and allows the contact portion to be in close contact with the straight portion.

4. The enclosed rotating electric machine according to claim 1, wherein
the protective member has a peripheral wall formed in a bellows shape in an axial direction of the protective member.
